(19) United States
(12) Patent Application Publication
(10) Pub. No.: US 2025/0161814 A1
(43) Pub. Date: May 22, 2025

(54) INTERACTION METHOD AND APPARATUS IN VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Zhihong LIU, Shenzhen (CN)

(21) Appl. No.: 19/030,902

(22) Filed: Jan. 17, 2025

Related U.S. Application Data
(63) Continuation of application No. PCT/CN2023/130182, filed on Nov. 7, 2023.

(30) Foreign Application Priority Data
Feb. 6, 2023 (CN) 202310122153.2

(51) Int. Cl. A63F 13/56; A63F 13/52; A63F 13/58

(52) U.S. Cl. CPC A63F 13/56; A63F 13/52; A63F 13/58

(57) ABSTRACT

This application provides a virtual object interaction in a virtual scene performed by an electronic device. The method includes: displaying a first virtual scene, the first virtual scene comprising a first virtual object controlled by a first player and a second virtual object controlled by a second player; in response to a trigger operation by the first virtual object pointing in a target direction, forming a trap having an impact range at a collision position of the trap item; when the second virtual object is within the impact range of the trap in the first virtual scene, replacing the first virtual scene with a second virtual scene, wherein the second virtual scene includes the second virtual object and not the first virtual object; and displaying a process of the second virtual object being controlled by the second player to perform an interaction task in the second virtual scene.

### CROSS-REFERENCE TO RELATED APPLICATIONS

This application is a continuation application of PCT Patent Application No. PCT/CN2023/130182, entitled “INTERACTION METHOD AND APPARATUS IN VIRTUAL SCENE, ELECTRONIC DEVICE, COMPUTER-READABLE STORAGE MEDIUM, AND COMPUTER PROGRAM PRODUCT” filed on Nov. 7, 2023, which is based upon and claims priority to Chinese Patent Application No. 202310122153.2, entitled “INTERACTION METHOD AND APPARATUS IN VIRTUAL SCENE, ELECTRONIC DEVICE, COMPUTER-READABLE STORAGE MEDIUM, AND COMPUTER PROGRAM PRODUCT” filed on Feb. 6, 2023, both of which are incorporated by reference in their entirety.

### FIELD OF THE TECHNOLOGY

This application relates to computer human-computer interaction technologies, and in particular, to an interaction method and apparatus in a virtual scene, an electronic device, a computer-readable storage medium, and a computer program product.

### BACKGROUND OF THE DISCLOSURE

A display technology based on graphics processing hardware expands a channel for perceiving an environment and obtaining information. Especially, a multimedia technology of a virtual scene can implement, based on an actual implementation need by using a human-computer interaction engine technology, diversified interactions between virtual objects that are controlled by users or artificial intelligence; and has various typical application scenarios, for example, in a virtual scene such as a game, can simulate an actual battle process between the virtual objects.

A player controls the virtual object to interact in the virtual scene, to obtain a victory of a game. In an interaction process in the virtual scene, some virtual objects may be restricted from moving for various reasons. For example, some virtual objects may be blocked in a particular area in the virtual scene. However, when the virtual object is restricted from moving, the corresponding player cannot participate in the game, leading to low efficiency of human-computer interaction, and a waste of related computing communication resources.

### SUMMARY

Embodiments of this application provide an interaction method and apparatus in a virtual scene, an electronic device, a computer-readable storage medium, and a computer program product, to improve interaction diversity in the virtual scene.

Technical solutions in the embodiments of this application are implemented as follows.

The embodiments of this application provide a virtual object interaction method in a virtual scene performed by an electronic device and the method includes:
displaying a first virtual scene, the first virtual scene comprising a first virtual object controlled by a first player and a second virtual object controlled by a second player, wherein the first virtual object holds a trap jamming item;
in response to a trigger operation by the first virtual object pointing in a target direction using the trap jamming item, controlling a trap item fired by the trap jamming item to move along the target direction and forming a trap having an impact range at a collision position of the trap item;
in accordance with a determination that the second virtual object is within the impact range of the trap in the first virtual scene, replacing the first virtual scene with a second virtual scene, wherein the second virtual scene includes the second virtual object and not the first virtual object; and
displaying a process of the second virtual object being controlled by the second player to perform an interaction task in the second virtual scene.

The embodiments of this application provide an electronic device, including:
a memory, configured to store computer-executable instructions; and
a processor, configured to implement the interaction method in a virtual scene according to the embodiments of this application when executing the computer-executable instructions stored in the memory.

The embodiments of this application provide a computer-readable storage medium, having computer-executable instructions stored therein, the computer-executable instructions, when executed by a processor, implementing the interaction method in a virtual scene according to the embodiments of this application.

The embodiments of this application include the following beneficial effects.

The second virtual object is controlled to enter the second virtual scene through the trap jamming operation of the first virtual object. This is equivalent to that the player controlling the first virtual object can perform an operation to make the second virtual object unable to interact in the first virtual scene, to provide more interaction manners and human-computer interaction modes for game players and improve human-computer interaction diversity. The second virtual object is controlled to enter the second virtual scene, and the process of the second virtual object performing the interaction task in the second virtual scene is displayed, so that the second virtual object can perform game interaction in the second virtual scene. Therefore, the game logic in the first virtual scene is not affected when an interaction requirement of the second virtual object is satisfied, and efficiency of human-computer interaction and utilization of related computing communication resources are improved. In addition, through expansion of the virtual scene, utilization of display resources can be improved, and a broader visual space can be provided for the player.

### BRIEF DESCRIPTION OF THE DRAWINGS

FIG. 1A to FIG. 1C are schematic structural diagrams of an interaction system in a virtual scene according to an embodiment of this application.

FIG. 2 is a schematic structural diagram of an electronic device according to an embodiment of this application.

FIG. 3A to FIG. 3C are schematic flowcharts of an interaction method in a virtual scene according to an embodiment of this application.

FIG. 4 is a schematic flowchart of an interaction method in a virtual scene according to an embodiment of this application.

FIG. 5A to FIG. 5C are schematic diagrams of an interface of an interaction method in a virtual scene according to an embodiment of this application.

FIG. 6A and FIG. 6B are schematic diagrams of an interface of an interaction method in a virtual scene according to an embodiment of this application.

FIG. 7A to FIG. 7D are schematic diagrams of an interface of an interaction method in a virtual scene according to an embodiment of this application.

FIG. 8 is a schematic flowchart of an interaction method in a virtual scene according to an embodiment of this application.

FIG. 9 is a schematic diagram of an attack principle of an interaction method in a virtual scene according to an embodiment of this application.

FIG. 10A to FIG. 10C are schematic diagrams of an interaction task principle of an interaction method in a virtual scene according to an embodiment of this application.

### DESCRIPTION OF EMBODIMENTS

To make objectives, technical solutions, and advantages of this application clearer, the following further describes this application in detail with accompanying drawings. The described embodiments do not be construed as limitation on this application. All other embodiments obtained by a person of ordinary skill in the art based on embodiments of this application without creative efforts shall fall within the protection scope of this application.

“Some embodiments” involved in the following descriptions describes a subset of all possible embodiments. However, “some embodiments” may be same or different subsets of all the possible embodiments, and may be combined with each other when there is no conflict.

In the following descriptions, the terms “first”, “second”, and “third” are merely intended to distinguish between similar objects and do not indicate a specific sequence of the objects. A specific order or sequence of the “first”, “second”, and “third” may be interchanged if permitted, so that the embodiments of this application described herein may be implemented in a sequence other than the sequence illustrated or described herein.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, terms involved in the embodiments of this application are described, and the following explanations are applicable to the terms involved in the embodiments of this application.
(1) A virtual scene is a scene outputted by a device and different from the real world. Visual perception of the virtual scene, for example, a two-dimensional image outputted through a display screen, or a three-dimensional image outputted through a stereoscopic display technology such as a stereoscopic projection technology, a virtual reality technology, or an augmented reality technology, can be formed through naked eyes or with assistance of the device. In addition, various real world simulation perception such as auditory perception, tactile perception, olfactory perception, and motion perception may further be formed through various possible hardware.
(2) “In response to” is configured for representing a condition or a status on which an executed operation depends, and when a dependent condition or status is met, one or more executed operations may be in real time or may have a set delay. There is no limitation on a sequence in which operations are performed without particular description.
(3) A virtual object is an object interacting in the virtual scene, is controlled by a user or a robot program (for example, a robot program based on artificial intelligence), and is an object that can stand still, move, and perform various behaviors in the virtual scene, for example, various characters in a game.
(4) A skill chip is an item configured to endow a special capability to a game character. For example, a virtual character may be endowed with a new capability, or another item (such as a virtual shooting item) held by a virtual character may be endowed with a new capability, for example, emitting a disguise signal.

A game in the related technologies may use various interaction modes to attract a player, for example, a one-to-one battle mode, that is, an enemy is attacked to obtain a score, or a victory may be obtained by attacking set enemies in priority. However, this interaction mode is basic, and a new element may be added to implement a new interaction mode. For example, a virtual object may be limited, so that the virtual object cannot interact (move, attack, use an item, or the like) in the game in a time period. Therefore, interaction diversity and complexity in the virtual scene may be improved through an interaction mechanism.

However, during implementation of the embodiments of this application, the applicant found that in the related art, when the virtual object is restricted from moving, the corresponding player cannot participate in the game, leading to low efficiency of human-computer interaction, and a waste of related computing communication resources. In addition, generally, a restriction for the virtual object is sent by a backed system, and it is difficult to implement a restriction between virtual objects through interaction, which is equivalent to restricting human-computer interaction diversity and interaction diversity in the virtual scene.

The embodiments of this application provide an interaction method and apparatus in a virtual scene, an electronic device, a computer-readable storage medium, and a computer program product, to improve the interaction diversity in the virtual scene. The following describes exemplary applications of the electronic device provided in the embodiments of this application. The electronic device provided in the embodiments of this application may be implemented as various types of user terminals such as a notebook computer, a tablet computer, a desktop computer, a set-top box, a mobile device (for example, a mobile phone, a portable music player, a personal digital assistant, a dedicated message device, and a portable game device).

For ease of understanding the interaction method in a virtual scene provided in the embodiments of this application, first, an exemplary implementation scenario of the interaction method in a virtual scene provided in the embodiments of this application is described. The virtual scene may be completely outputted based on a terminal, or may be outputted based on cooperation of a terminal and a server.

In some embodiments, the virtual scene may be an environment for game characters to interact, for example, may be an environment for game characters to fight in the virtual scene. Actions of the virtual objects may be controlled for both parties to interact in the virtual scene.

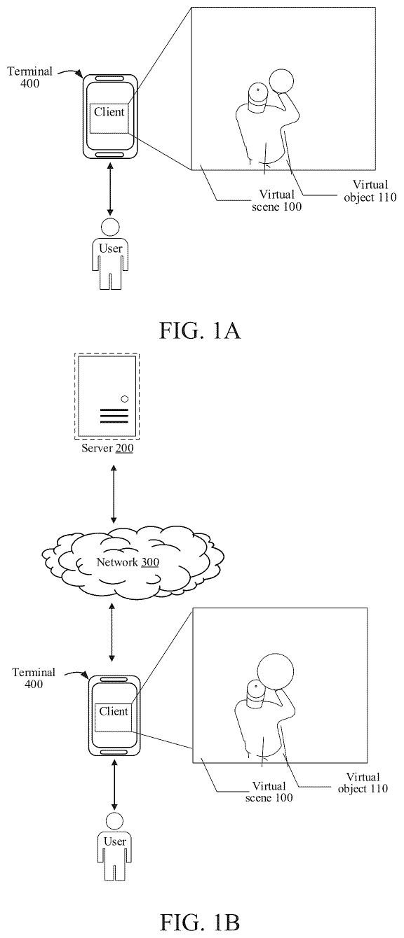

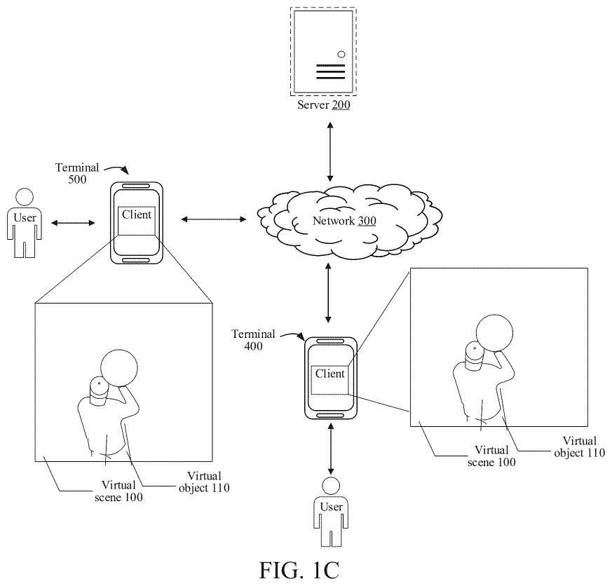

In an implementation scenario, referring to FIG. 1A, FIG. 1A is a schematic diagram of an application mode of an interaction method in a virtual scene. The method is applicable to some application modes that completely depend on computing power of a terminal 400 to complete related data calculation of a virtual scene 100. For example, in a game in a single player version or an offline mode, the terminal 400 such as a smartphone, a tablet computer, or a virtual reality/augmented reality device is used to complete output of the virtual scene.

When forming visual perception of the virtual scene 100 (including a virtual object 110), the terminal 400 calculates data needed for display by using graphics computing hardware, completes loading, parsing, and rendering of display data, and outputs, at the graphics output hardware, a video frame that can form the visual perception of the virtual scene, for example, a two-dimensional video frame that is displayed on a display screen of the smartphone, or a video frame for implementing a three-dimensional display effect that is projected on lenses of augmented reality/virtual reality glasses. In addition, to enrich a perception effect, the device may further use different hardware to form one or more of auditory perception, tactile perception, motion perception, and taste perception.

For example, the terminal 400 runs a client (such as a game application in the single player version), and outputs a virtual scene including role play in a running process of the client. The virtual scene is an environment for the game characters to interact, for example, may be plains, streets, and valleys for the game characters to fight. A first virtual scene is displayed on the terminal 400. The first virtual scene includes a first virtual object. The first virtual object is a virtual object controlled by a player. In response to a trap jamming operation of the first virtual object, a second virtual scene is displayed on a human-computer interaction interface of the terminal 400, and a second virtual object is displayed in the second virtual scene. The second virtual object is a virtual object within an impact range of the trap jamming operation in the first virtual scene when the trap jamming operation is triggered. A process of the second virtual object being controlled to perform an interaction task in the second virtual scene is displayed. The terminal 400 may be a terminal used by a player controlling the first virtual object. The second virtual object may be a virtual object controlled by a non-player. The player controlling the first virtual object may observe, through the terminal 400, the process of the second virtual object performing the interaction task in the second virtual scene.

In another implementation scenario, referring to FIG. 1B, FIG. 1B is a schematic diagram of an application mode of an interaction method in a virtual scene. The method is applied to a terminal 400 and a server 200, and is generally applicable to an application mode that depends on computing power of the server 200 to complete computing of the virtual scene and output the virtual scene in the terminal 400.

Visual perception of a virtual scene 100 (including a virtual object 110) being formed is used as an example. The server 200 calculates related display data of the virtual scene, and sends the display data to the terminal 400. The terminal 400 depends on graphics computing hardware to complete loading, parsing, and rendering of calculation of the display data, and depends on graphics output hardware to output the virtual scene to form the visual perception, for example, may display a two-dimensional video frame on a display screen of a smartphone, or project a video frame for implementing a three-dimensional display effect on lenses of augmented reality/virtual reality glasses. For perception in a form of the virtual scene, related hardware of the terminal may be used for output, for example, microphone output is used to form auditory perception, and vibrator output is used to form tactile perception.

For example, the terminal 400 runs a client (for example, an online game application), and performs game interaction with another user by connecting to a game server (that is, the server 200). A first virtual scene is displayed on the terminal 400. The first virtual scene includes a first virtual object. The first virtual object is a virtual object controlled by a player. The terminal 400 sends, in response to a trap jamming operation of the first virtual object, operation data of the trap jamming operation to the server 200. The server 200 obtains display data of a second virtual scene, and returns the display data to the terminal 400. The second virtual scene is displayed on a human-computer interaction interface of the terminal 400, and the second virtual object is displayed in the second virtual scene. The second virtual object is a virtual object within an impact range of the trap jamming operation in the first virtual scene when the trap jamming operation is triggered. The process of the second virtual object being controlled to perform an interaction task in the second virtual scene is displayed. The terminal 400 may be a terminal used by a player controlling the first virtual object. The second virtual object may be a virtual object controlled by a non-player. The player controlling the first virtual object may observe, through the terminal 400, the process of the second virtual object performing the interaction task in the second virtual scene.

In another implementation scenario, referring to FIG. 1C, FIG. 1C is a schematic diagram of an application mode of an interaction method in a virtual scene. The method is applied to a terminal 400, a terminal 500, and a server 200, and is generally applicable to an application mode that depends on computing power of the server 200 to complete computing of the virtual scene and output the virtual scene in the terminal 400 and the terminal 500.

Visual perception of a virtual scene 100 (including a virtual object 110) being formed is used as an example. The server 200 calculates related display data of the virtual scene, and sends the display data to the terminal 400 and the terminal 500. The terminal 400 and the terminal 500 depend on graphics computing hardware to complete loading, parsing, and rendering of calculation of the display data, and depend on graphics output hardware to output the virtual scene to form the visual perception, for example, may display a two-dimensional video frame on a display screen of a smartphone, or project a video frame for implementing a three-dimensional display effect on lenses of augmented reality/virtual reality glasses. For perception in a form of the virtual scene, related hardware of the terminal may be used for output, for example, microphone output is used to form auditory perception, and vibrator output is used to form tactile perception.

For example, the terminal 400 and the terminal 500 run a client (for example, an online game application), and perform game interaction with each other by connecting to a game server (that is, the server 200). A first virtual scene is displayed on the terminal 400. The first virtual scene includes a first virtual object. The first virtual object is a virtual object controlled by a player A. The terminal 400 sends, in response to a trap jamming operation of the first virtual object, operation data of the trap jamming operation to the server 200. The server 200 obtains display data of the second virtual scene, and returns the display data to the terminal 400 and the terminal 500. The second virtual scene is displayed on a human-computer interaction interface of the terminal 500, and a second virtual object is displayed in the second virtual scene. The second virtual object is a virtual object within an impact range of the trap jamming operation in the first virtual scene when the trap jamming operation is triggered. The process of the second virtual object being controlled to perform an interaction task in the second virtual scene is displayed. The terminal 400 may be a terminal used by a player controlling the first virtual object. The terminal 500 may be a terminal used by a player controlling the second virtual object. The player controlling the first virtual object may also observe, through the terminal 400, the process of the second virtual object performing the interaction task in the second virtual scene.

In some embodiments, the terminal 400 may implement the interaction method in a virtual scene provided in the embodiments of this application by running a computer program. For example, the computer program may be an original program or a software module in an operating system, or may be a native application (APP), that is, a program that needs to be installed in an operating system to run, for example, a game APP (that is, the foregoing client), or may be a mini program, that is, a program that only needs to be downloaded to a browser environment to run, or may be a game mini program that can be embedded in any APP. In conclusion, the computer program may be any form of an application, a module, or a plug-in.

The embodiments of this application may be implemented by using a cloud technology. The cloud technology is a hosting technology that unifies a series of resources such as hardware, software, and a network in a wide area network or a local area network, to implement data computing, storage, processing, and sharing.

Cloud technology is a general term for a network technology, an information technology, an integration technology, a management platform technology, an application technology, and the like that are applied based on a cloud computing business model. The technologies can form a resource pool to be flexibly used on demand. A cloud computing technology is becoming an important support. A background service of a technical network system needs a large quantity of computing and storage resources.

For example, the server 200 may be an independent physical server, or a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a CDN, and big data and an artificial intelligence platform. The terminal 400 may be a smartphone, a tablet computer, a laptop computer, a desktop computer, a smart speaker, and a smart watch, but this is not limited thereto. The terminal 400 and the server 200 may be connected directly or indirectly in a wired or wireless communication manner. This is not limited in the embodiments of this application.

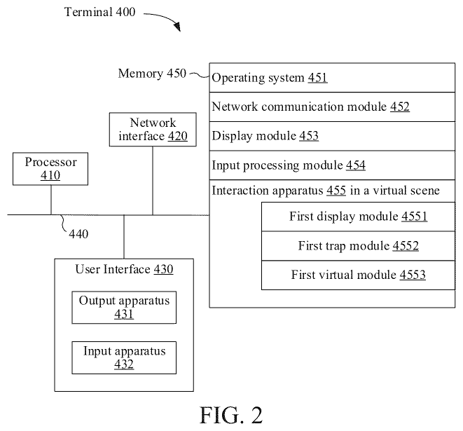

Referring to FIG. 2, FIG. 2 is a schematic structural diagram of an electronic device to which an interaction method in a virtual scene is applied according to an embodiment of this application. An example in which the electronic device is a terminal is used for description. The terminal 400 shown in FIG. 2 includes at least one processor 410, a memory 450, at least one network interface 420, and a user interface 430. All the components in the terminal 400 are coupled together by a bus system 440. The bus system 440 is configured to implement connection and communication between the components. In addition to a data bus, the bus system 440 further includes a power bus, a control bus, and a status signal bus. However, for ease of clear description, all types of buses are marked as the bus system 440 in FIG. 2.

The processor 410 may be an integrated circuit chip having a signal processing ability, for example, a general processor, a digital signal processor (DSP), or another programmable logic device, a discrete gate or a transistor logic device, or a discrete hardware component, where the general processor may be a microprocessor, any conventional processor, or the like.

The user interface 430 includes one or more output apparatuses 431 that can display media content, including one or more speakers and/or one or more visual displays. The user interface 430 also includes one or more input apparatuses 432, including a user interface component that facilitate user input such as a keyboard, a mouse, a microphone, a touchscreen display screen, a camera, another input button, or a control.

The memory 450 may be a removable memory, a non-removable memory, or a combination of a removable memory and a non-removable memory. Exemplary hardware devices include a solid state memory, a hard drive, an optical disk drive, and the like. In some embodiments, the memory 450 includes one or more storage devices physically remote from the processor 410.

The memory 450 may be a volatile memory or a non-volatile memory, or may include both a volatile memory and a non-volatile memory. The non-volatile memory may be a read only memory (ROM), or the volatile memory may be a random access memory (RAM). The memory 450 described in the embodiments of this application is intended to include, but is not limited to, memories of any suitable type.

In some embodiments, the memory 450 can store data to support various operations. An example of the data includes a program, a module, a data structure, or a subset or a superset of the data. The following is an example for description.

An operating system 451 includes a system program configured to handle various basic system services and perform a hardware related task, for example, a framework layer, a core library layer, or a driver layer, used for implementing various basic services and processing a task based on hardware.

A network communication module 452 is configured to reach another computing device through one or more (wired or wireless) network interfaces 420. Exemplary network interfaces 420 include Bluetooth, wireless fidelity (Wi-Fi), a universal serial bus (USB), and the like.

A display module 453 is configured to enable to present information (such as a user interface configured for operating a peripheral device and displaying content and information) through one or more output apparatuses 431 (such as the display screen and the speaker) associated with a user interface 430.

An input processing module 454 is configured to: detect one or more user enters or interactions from one or more input devices 432, and translate the detected input or interaction.

In some embodiments, an interaction apparatus in a virtual scene provided in the embodiments of this application may be implemented by using software. FIG. 2 shows an interaction apparatus 455 in a virtual scene that is stored in the memory 450. The interaction apparatus may be software in a form of a program, a plug-in, or the like, including the following software modules: a first display module 4551, a first trap module 4552, and a first virtual module 4553. Therefore, these modules are logical and can further be combined or split in different manners depending on implemented functions. The function of each module is described as follows.

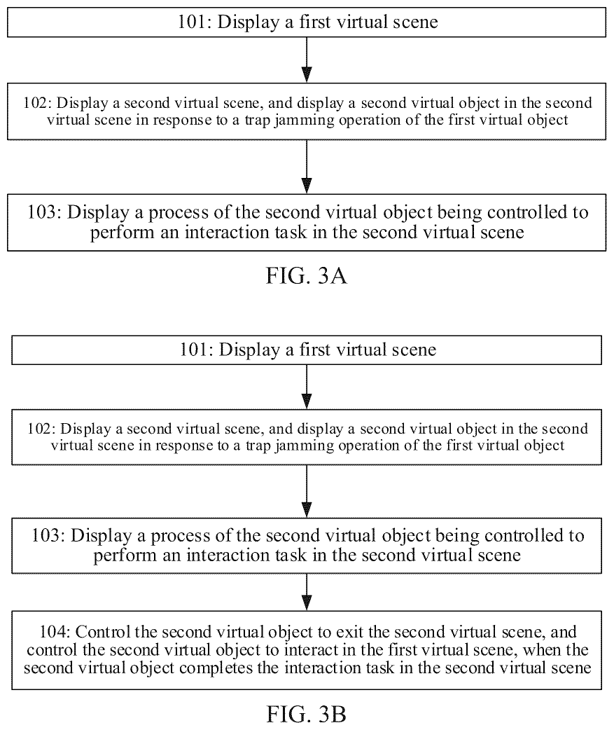

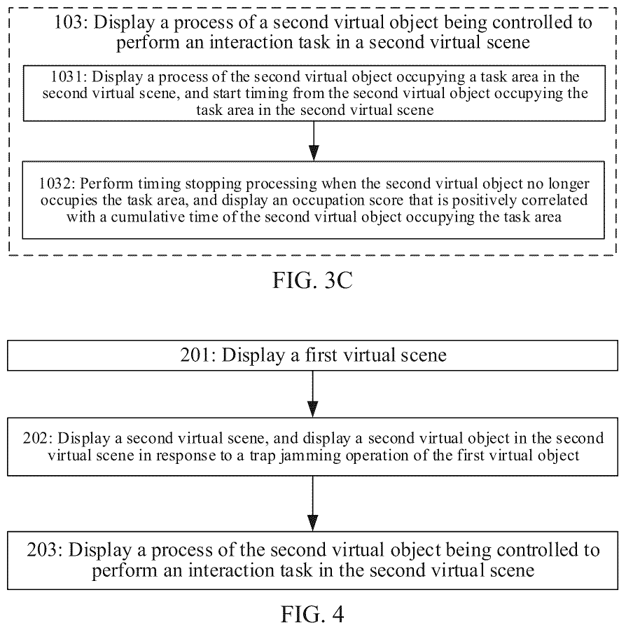

Referring to FIG. 3A below, FIG. 3A is a schematic flowchart of an interaction method in a virtual scene according to an embodiment of this application. Descriptions are provided with reference to operations shown in FIG. 3A.

The method shown in FIG. 3A may be performed by computer programs in various forms run by a terminal, and is not limited to the foregoing client, for example, the operating system, the software module, and the script. Therefore, the client is not considered as a limitation to this embodiment of this application.

Operation 101: Display a first virtual scene.

For example, the first virtual scene includes a first virtual object, the first virtual object is a virtual object controlled by a player, the first virtual scene is a main scene in which players play for victory after logging in to the game, and whether a player wins is determined based on scores obtained by the virtual object controlled by the player in the first virtual scene.

Operation 102: Display a second virtual scene, and display a second virtual object in the second virtual scene in response to a trap jamming operation of the first virtual object.

For example, the second virtual scene may be obtained based on the first virtual scene. For example, different special effect filters are used for the first virtual scene, or direction rotation is performed on the first virtual scene. The second virtual scene may alternatively be a virtual scene completely different from the first virtual scene. There may be a plurality of second virtual scenes in a game. In response to the trap jamming operation of the first virtual object, a target second virtual scene of a plurality of candidate second virtual scenes is displayed, and the second virtual object is displayed in the target second virtual scene. The target second virtual scene in which the current second virtual object enters is different from a second virtual scene in which the second virtual object previously entered.

For example, the second virtual object is a virtual object within an impact range of the trap jamming operation in the first virtual scene when the trap jamming operation is triggered, and the second virtual object may be a virtual object controlled by a player or a virtual object having a behavior mode and controlled through an AI technology. The second virtual object within the impact range may be sent to the second virtual scene through the trap jamming operation fired by the first virtual object. A terminal performing operation 102 may be a terminal used by a player controlling the first virtual object, or a terminal used by a player controlling the second virtual object.

Operation 103: Display a process of the second virtual object being controlled to perform an interaction task in the second virtual scene.

For example, the interaction task may be a task that the second virtual object interacts, in the second virtual scene, with a virtual element in the second virtual scene, or the interaction task may be simply that the second virtual object stays in the second virtual scene for a period of time. This is equivalent to that the second virtual object is controlled to be in the second virtual scene, and no interaction behavior can be performed in the first virtual scene. Because whether a player wins is determined based on the scores obtained by the virtual object controlled by a player in the first virtual scene, scores obtained by the second virtual object in the second virtual scene do not affect who wins the game, but only affect whether the second virtual object can return to the first virtual scene. Therefore, this is equivalent to that teammates of the second virtual object in the first virtual scene temporarily lose support of a partner, and during this period, the second virtual object cannot affect who wins the game.

In some embodiments, referring to FIG. 3B, after operation 103, operation 104 shown in FIG. 3B is performed. Operation 104: Control the second virtual object to exit the second virtual scene, and control the second virtual object to interact in the first virtual scene, when the second virtual object completes the interaction task in the second virtual scene. According to this embodiment of this application, it can help the second virtual object return to the first virtual scene to continue the game, thereby reducing consumption of rendering resources in the second virtual scene, and improving resource utilization.

For example, when the second virtual object completes the interaction task in the second virtual scene, for example, completes a specific interaction task or stays long enough in the second virtual scene, the second virtual object may leave the second virtual scene, and return to the first virtual scene again. This is equivalent to that the second virtual object may continue to interact in the first virtual scene, and play for victory of the game.

In some embodiments, when the second virtual object is in the second virtual scene, in response to a life status value of the first virtual object in the first virtual scene being less than a third life status threshold, the second virtual object is controlled to exit the second virtual scene, and the second virtual object is controlled to interact in the first virtual scene. According to this embodiment of this application, it can help the second virtual object return to the first virtual scene to continue the game, thereby reducing the consumption of the rendering resources in the second virtual scene, and improving the resource utilization.

For example, when the second virtual object is in the second virtual scene, interaction in the first virtual scene continues. The first virtual object may be attacked by another virtual object in the first virtual scene. After the first virtual object is attacked, a life status value of the first virtual object decreases. When the life status value of the first virtual object decreases to a value less than the third life status threshold (for example, the third life status threshold is 1), the impact generated by the trap jamming operation triggered by the first virtual object may be invalid. Therefore, the second virtual object may also leave the second virtual scene, and return to the first virtual scene again. This is equivalent to that the second virtual object may continue to interact in the first virtual scene. and play for victory of the game.

In some embodiments, as described in operation 102, in response to the trap jamming operation of the first virtual object, the second virtual scene is displayed, and the second virtual object is displayed in the second virtual scene. The jamming operation herein has various forms. For example, the first virtual object holds a trap jamming item, and the trap jamming operation is a trigger operation of the first virtual object pointing in a target direction using the trap jamming item. Before the second virtual scene is displayed, and the second virtual object is displayed in the second virtual scene, a trap item fired by the trap jamming item is controlled to move along the target direction, and a trap having the impact range is formed at a collision position of the trap item. According to this embodiment of this application, the trap jamming operation may be implemented through the item, so that the player has a sense of control, thereby improving human-computer interaction experience.

For example, the trap jamming item (which may be a reused existing item) includes at least one of the following: a throwing object and a shooting item. The trap jamming item may be used to determine the target direction. For example, when the trap jamming item is the throwing object, after a virtual element is aimed at, the target direction is a throwing direction after aiming; or when the trap jamming item is the shooting item, after a virtual element is aimed at, the target direction is a shooting direction after aiming. When the trap jamming item is the throwing object, the trap having the impact range is formed at at least one collision position of a parabolic curve; or when the trap jamming item is the shooting item, the trap having the impact range is formed at a collision position at which a fired bullet having a trap jamming function lands after flying, or the trap having the impact range is formed at a collision position at which a fired bullet having a trap jamming function collides with any virtual element after flying. The virtual element herein may be any entity in the virtual scene.

In some embodiments, as described in operation 102, in response to the trap jamming operation of the first virtual object, the second virtual scene is displayed, and the second virtual object is displayed in the second virtual scene. The jamming operation herein has various forms. For example, the first virtual object has a trap jamming skill, and the trap jamming operation is a trigger operation based on the trap jamming skill and implemented by controlling the first virtual object. Before the second virtual scene is displayed, and the second virtual object in the second virtual scene is displayed, a trap having the impact range is formed at a position to which the trap jamming operation points. According to this embodiment of this application, operation difficulty of a user can be reduced, and efficiency of human-computer interaction of a player can be improved.

For example, a trigger button of the trap jamming skill is displayed on the human-computer interaction interface, a skill setting interface is displayed in response to a tap operation on the trigger button of the trap jamming skill, and a trap having the impact range is formed at a set position in response to receiving a position set on the skill setting interface. The trap herein may be displayed through a model or through a special effect.

In some embodiments, operation 102 of displaying the second virtual scene, and displaying the second virtual object in the second virtual scene may be implemented through the following technical solutions: displaying, when the second virtual object is outside the impact range of the trap at a moment at which the trap jamming operation is triggered, a process of the second virtual object moving in the first virtual scene; and displaying the second virtual scene, and displaying the second virtual object in the second virtual scene when the second virtual object moves from outside the impact range of the trap to inside the impact range of the trap in the first virtual scene. According to this embodiment of this application, an interaction range of the trap jamming operation in a time dimension can be improved, and an effective operation time can be improved, thereby improving the efficiency of human-computer interaction.

For example, if the second virtual object is not within the impact range of the trap when the trap is formed, the second virtual object is not sent to the second virtual scene. After the second virtual object moves into the impact range of the trap, the second virtual object is sent to the second virtual scene, representing that the trap has an effect on the second virtual object.

In some embodiments, operation 102 of displaying the second virtual scene, and displaying the second virtual object in the second virtual scene may be implemented through the following technical solutions: displaying the second virtual scene, and displaying the second virtual object in the second virtual scene when the second virtual object is already within the impact range of the trap at a moment at which the trap jamming operation is triggered. According to this embodiment of this application, operation efficiency and interference accuracy of the trap jamming operation can be improved.

For example, if when the trap jamming operation is triggered, the second virtual object is just within the impact range of the trap jamming operation, that is, within the impact range of the trap, the second virtual object is sent to the second virtual scene in real time with the formation of the trap. For example, a position of the second virtual object is just a position to which the trap jamming operation points, or a position of the second virtual object is just a position to which the trap item fired by the trap jamming item moves along the target direction and is at the collision position of the trap item.

In some embodiments, any one of the following processing is performed: continuing to display the second virtual object in the first virtual scene in response to the trap jamming operation of the first virtual object, the second virtual object being in an interaction-blocking state; or blocking displaying of the second virtual object in the first virtual scene in response to the trap jamming operation of the first virtual object. According to this embodiment of this application, interaction of the second virtual object in the first virtual scene may be isolated, to implement a trap jamming function of the second virtual object, which can satisfy an interaction requirement of the second virtual object without affecting the game logic in the first virtual scene.

For example, when the second virtual object is sent to the second virtual scene, a model of the second virtual object may continue to be displayed in the first virtual scene, that is, another virtual object in the first virtual scene can still observe the second virtual object in the first virtual scene, but the second virtual object in the first virtual scene cannot move or attack others, but will not be attacked either, and may be considered not to be involved in any interaction. To prevent another virtual object from triggering an invalid interaction operation for the second virtual object, prompt information may be displayed to prompt that the second virtual object is sent to the second virtual scene. The second virtual object sent to the second virtual scene may be a copy model of the second virtual object reserved in the first virtual scene. When the second virtual object is sent to the second virtual scene, the second virtual object may alternatively not be displayed in the first virtual scene. For example, prompt information is displayed to prompt that the second virtual object is sent to the second virtual scene.

In some embodiments, before in response to the trap jamming operation of the first virtual object, a trap jamming function is displayed in an activated state when at least one of the following conditions is satisfied: an activation operation for the trap jamming function is received, and an interval time from a previous response to the trap jamming operation exceeds an interval time threshold, where the trap jamming function being in the activated state represents that the trap jamming operation can be responded to. According to this embodiment of this application, a frequency at which a jamming function is used can be controlled, and calculation resources in the virtual scene can be reduced.

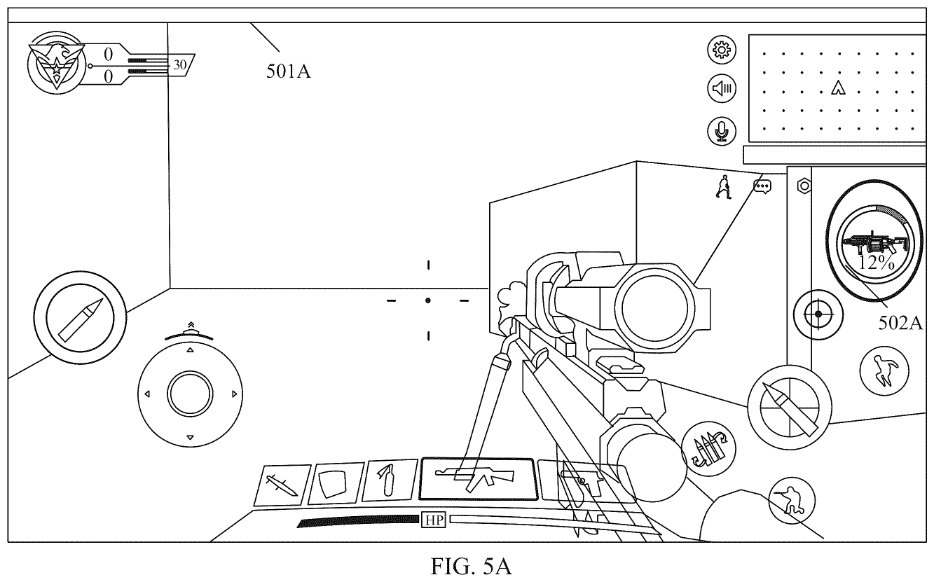

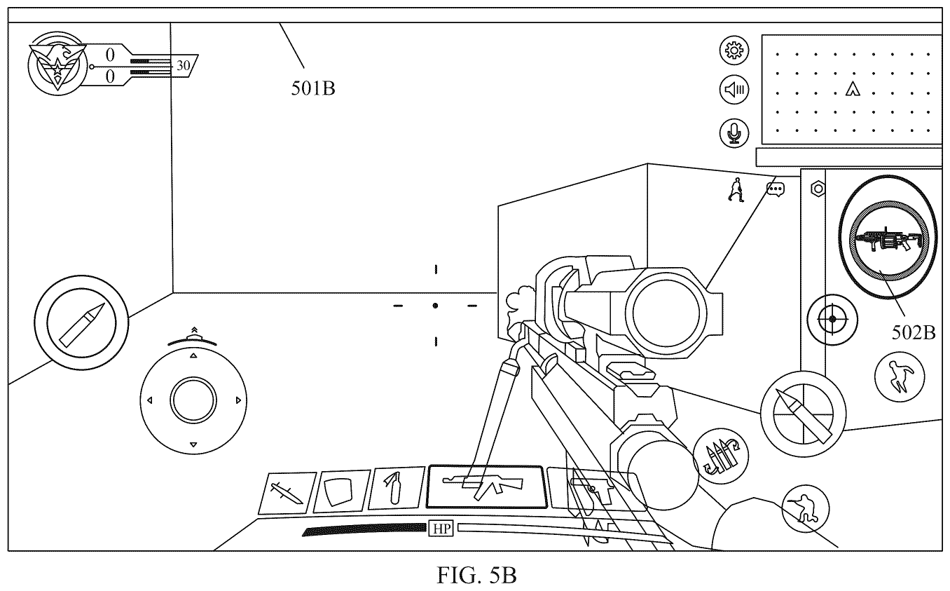

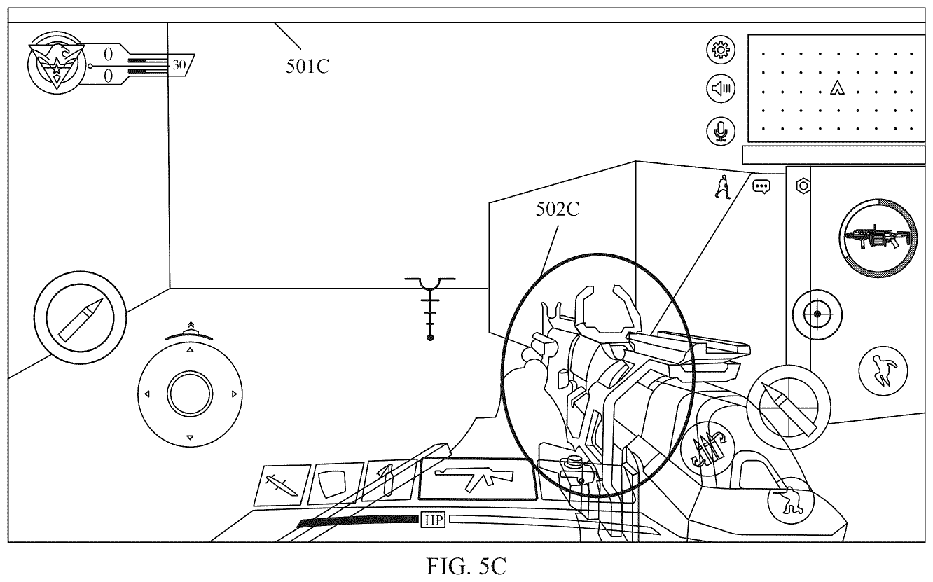

For example, in some embodiments, referring to FIG. 5A, a progress bar in a skill icon 502A is displayed on a human-computer interaction interface 501A. An item that may provide the trap jamming function (the trap jamming item) is an important item, and a use frequency of the important item needs to be controlled. Therefore, each virtual object may be equipped with one important item. The important item may be used repeatedly, but a time gap is required after each use. 12% displayed in the progress bar shown in FIG. 5A represents that it still needs to keep waiting for a period of time, and the important item is in an unusable state at this time. Referring to FIG. 5B, a progress bar of a skill icon 502B is displayed on a human-computer interaction interface 501B. When the progress bar shown in FIG. 5B reaches 100%, the skill icon 502B is highlighted, which indicates that the important item is usable. In response to a trigger operation for the skill icon 502B in FIG. 5B, a human-computer interaction interface 501C shown in FIG. 5C is displayed, and a trap jamming item 502C is switched out, and is equipped on a shooting item.

In some embodiments, referring to FIG. 3C, operation 103 of displaying a process of the second virtual object performing the interaction task in the second virtual scene may be implemented through operation 1031 and operation 1032 shown in FIG. 3C.

Operation 1031: Display a process of the second virtual object occupying a task area in the second virtual scene, and start timing from the second virtual object occupying the task area in the second virtual scene.

In some embodiments, the displaying a process of the second virtual object occupying a task area in the second virtual scene may be implemented through the following technical solutions: displaying prompt information, the prompt information being configured for indicating the second virtual object to occupy the task area; displaying a task area identifier in the task area, to prompt the second virtual object to enter the task area; and displaying the task area identifier in an occupied state in response to the second virtual object entering the task area. According to this embodiment of this application, convenience of task interaction in the virtual scene can be improved, and the efficiency of human-computer interaction can be improved.

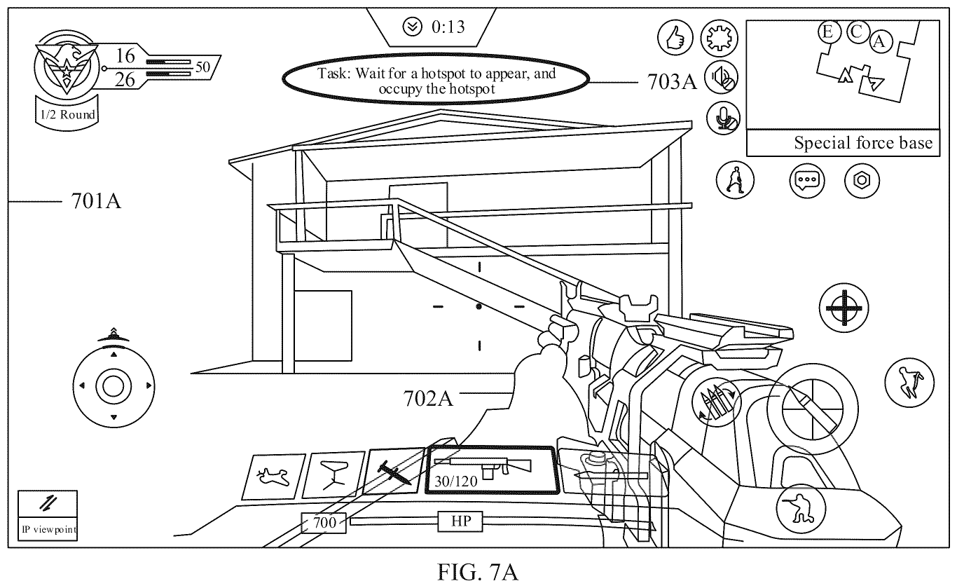

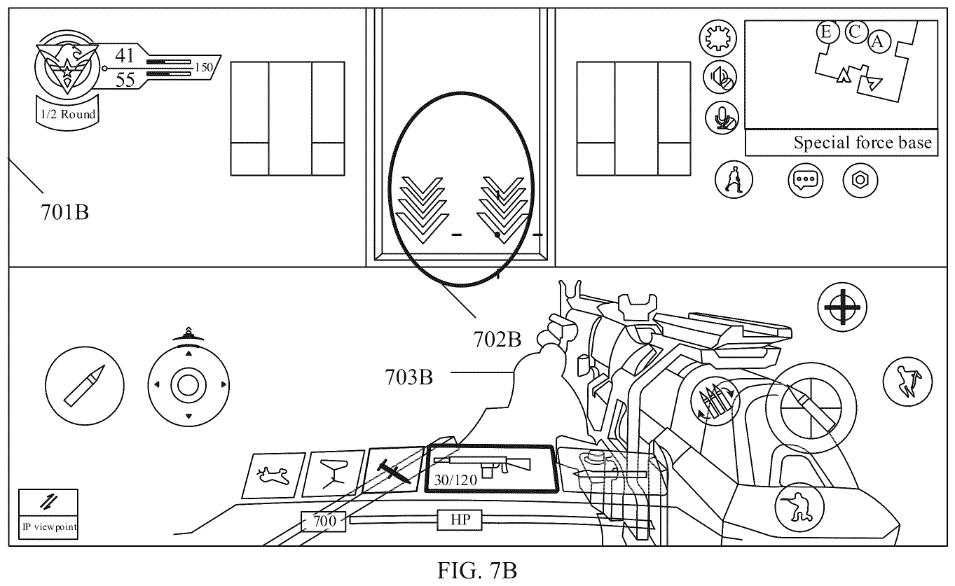

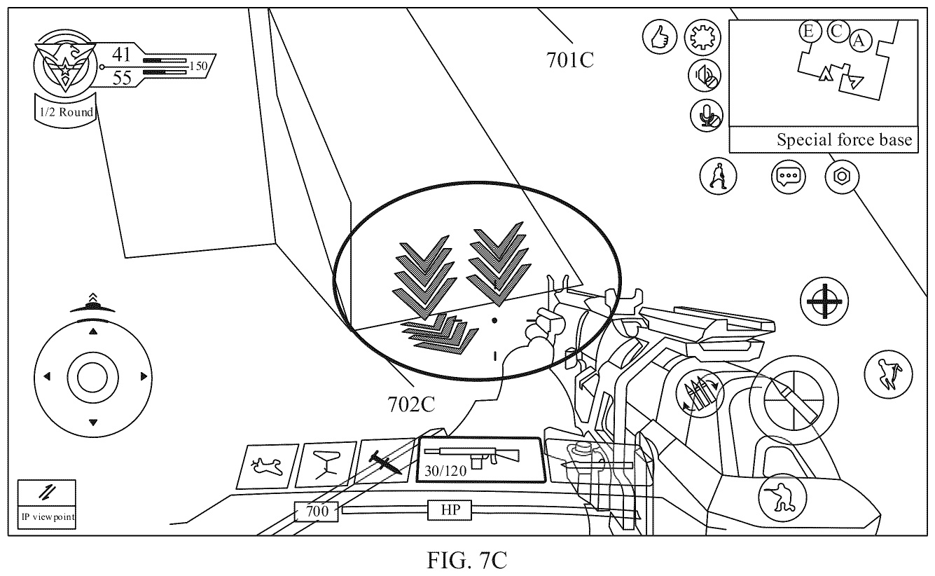

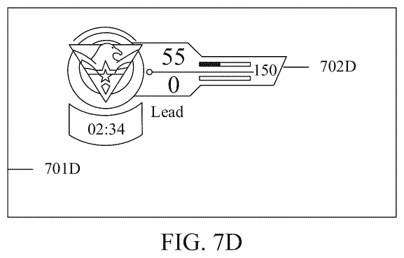

For example, referring to FIG. 7A, another virtual scene (different from the virtual scene shown in a human-computer interaction interface 601A) is displayed on a human-computer interaction interface 701A. After a virtual object 702A enters the virtual scene, an indication 703A pops up in the middle of the human-computer interaction interface, and the indication 703A informs the virtual object 702A of a task that needs to be completed. Referring to FIG. 7B, a hotspot identifier 702B is displayed on a human-computer interaction interface 701B. A virtual object 702B needs to find a hotspot (a task area) in a task, and occupies the hotspot. A virtual object 703B may find the hotspot identifier 702B, and enter the hotspot identifier 702B, to occupy the hotspot. Referring to FIG. 7C, a hotspot identifier 702C in a human-computer interaction interface 701C is initially white. After the virtual object occupies the hotspot, the hotspot identifier 702C turns blue. If another virtual object in the virtual scene occupies the hotspot, the hotspot identifier 702C turns red.

Operation 1032: Perform timing stopping processing when the second virtual object no longer occupies the task area, and display an occupation score that is positively correlated with a cumulative time of the second virtual object occupying the task area.

After operation 1032 is performed, when the occupation score reaches a set score, it is determined that the second virtual object completes the interaction task.

For example, when another virtual object in the second virtual scene expels the second virtual object from the task area, or when another virtual object in the second virtual scene occupies the task area, timing stopping processing needs to be performed, that is, only the cumulative time of the second virtual object occupying the task area is counted, and the occupation score that is positively correlated with the cumulative time of the second virtual object occupying the task area is displayed. Referring to FIG. 7D, a score control 702D is displayed on a human-computer interaction interface 701D, and the score control 702D is configured to: display a score of the virtual object controlled by a player controlling the human-computer interaction interface and a score of another virtual object, obtain a corresponding score based on a duration for which the hotspot is occupied, and complete the task when the score reaches a set value.

In some embodiments, the set score is negatively correlated with a first parameter and is positively correlated with a second parameter, the first parameter includes a distance between the second virtual object and a center of the impact range, and the second parameter is a life status value of the first virtual object when the trap jamming operation is triggered. According to this embodiment of this application, task difficulty can be dynamically controlled, and interaction diversity can be improved.

For example, a smaller distance between the second virtual object and the center of the impact range indicates the second virtual object being deeper trapped by the trap, so that the set score is higher. Therefore, it is harder for the second virtual object to complete the task and exit from the second virtual scene. A larger life status value of the first virtual object when the trap jamming operation is triggered indicates a stronger trap created by the first virtual object and the second virtual object being deeper trapped by the trap, so that the set score is higher.

In some embodiments, when the second virtual object is attacked by a third virtual object in the second virtual scene, a life status value of the second virtual object in the second virtual scene is reduced; and when the life status value of the second virtual object in the second virtual scene is less than a first life status threshold, the life status value of the second virtual object in the second virtual scene is initialized, and the cumulative time is set to zero to continue to perform the interaction task. According to this embodiment of this application, the game logic of the second virtual object in the second virtual scene can be implemented in a closed loop. In other words, even if the life status value of the second virtual object in the second virtual scene is less than the first life status threshold, the second virtual object does not return to the first virtual scene, to affect the game logic in the first virtual scene.

For example, when a life status value of the virtual object in a virtual world is zero, the task is restarted. In this case, the second virtual object has a same configuration as if the second virtual object just enters the second virtual scene, and starts to perform the task again. A player cannot leave the virtual world (the second virtual scene) to return to the real world (the first virtual scene) until completing the task, that is, circulate repeatedly in the second virtual scene. When the virtual object is in the virtual world, the virtual object in the real world is in an unbeatable state and an unmovable state. That is, a player that cannot get out of the virtual world cannot assist a teammate in a real game scene.

In some embodiments, the displaying the process of the second virtual object performing the interaction task in the second virtual scene may be implemented through the following technical solutions: reducing a life status value of the first virtual object in the second virtual scene in response to an attack operation of the second virtual object on the first virtual object in the second virtual scene when the first virtual object enters the second virtual scene; and determining, when the life status value of the first virtual object in the second virtual scene is less than a second life status threshold, that the second virtual object completes the interaction task. According to this embodiment of this application, an interaction scene of the first virtual object may be expanded, and the interaction scene of the first virtual object may be expanded from the first virtual scene to the second virtual scene, to provide an interaction opportunity between the first virtual object and the second virtual object.

For example, when the second virtual object is in the second virtual scene, the first virtual object may alternatively enter the second virtual scene in response to the trap jamming operation of another virtual object. The first virtual object may be attacked by the second virtual object in the second virtual scene. After the first virtual object is attacked, the life status value of the first virtual object decreases. When the life status value of the first virtual object decreases to a value less than the second life status threshold (for example, the second life status threshold is 1), the impact generated by the trap jamming operation triggered by the first virtual object may be invalid. Therefore, the second virtual object may also leave the second virtual scene, and return to the first virtual scene again. This is equivalent to that the second virtual object may continue to interact in the first virtual scene, and play for victory of the game.

In some embodiments, an amount of reduction on the life status value of the first virtual object in the second virtual scene by each attack operation is positively correlated with a first parameter and is negatively correlated with a second parameter, the first parameter includes a distance between the second virtual object and a center of the impact range, and the second parameter is the life status value of the first virtual object when the trap jamming operation is triggered. According to this embodiment of this application, the task difficulty can be dynamically controlled, and the interaction diversity can be improved.

For example, a smaller distance between the second virtual object and the center of the impact range indicates the second virtual object being deeper trapped by the trap. Therefore, each attack operation reduces the life status value of the first virtual object in the second virtual scene by a smaller amount, so that the first virtual object does not cause much impact each time the first virtual object is attacked, and the life status value cannot easily fall below the second life status threshold. Therefore, it is harder for the second virtual object to complete the task and exit from the second virtual scene. A larger life status value of the first virtual object when the trap jamming operation is triggered indicates a stronger trap created by the first virtual object and the second virtual object being deeper trapped by the trap. Therefore, each attack operation reduces the life status value of the first virtual object in the second virtual scene by a smaller amount.

Referring to FIG. 4 below, FIG. 4 is a schematic flowchart of an interaction method in a virtual scene according to an embodiment of this application. Descriptions are provided with reference to operations shown in FIG. 4.

The method shown in FIG. 4 may be performed by computer programs in various forms run by a terminal, and is not limited to the foregoing client, for example, the operating system, the software module, and the script. Therefore, the client is not considered as a limitation to this embodiment of this application.

Operation 201: Display a first virtual scene.

For example, the first virtual scene includes a first virtual object.

Operation 202: Display a second virtual scene, and display a second virtual object in the second virtual scene in response to a trap jamming operation of the first virtual object.

For example, the second virtual object is a virtual object within an impact range of the trap jamming operation in the first virtual scene when the trap jamming operation is triggered, and the second virtual scene is another virtual scene completely different from the first virtual scene.

Operation 203: Display a process of the second virtual object being controlled to perform an interaction task in the second virtual scene.

For specific implementations of operation 201 to operation 203, refer to operation 101 to operation 103, and a difference is that the second virtual scene in operation 101 to operation 103 may be obtained based on the first virtual scene, for example, different special effect filters are used in the first virtual scene, or direction rotation is performed for the first virtual scene. However, the second virtual scene used in operation 201 to operation 203 is another virtual scene completely different from the first virtual scene, and the second virtual object may complete the interaction task in the another virtual scene completely different from the first virtual scene. Therefore, a game space of players is expanded, players can be attracted to explore in the second virtual scene, thereby improving interaction diversity between players and virtual scenes.

The following describes an example application in an actual application scenario in the embodiments of this application.

A terminal A and a terminal B run a client (for example, an online game application), and perform game interaction with each other by connecting to a game server (that is, a server). A first virtual scene is displayed on the terminal A. The first virtual scene includes a first virtual object. The first virtual object is a virtual object controlled by a player A. The terminal A sends, in response to a trap jamming operation of the first virtual object, operation data of the trap jamming operation to the server. The server obtains display data of a second virtual scene, and returns the display data to the terminal A and the terminal B. The second virtual scene is displayed on a human-computer interaction interface of the terminal B and the second virtual object is displayed in the second virtual scene. The second virtual object is a virtual object within an impact range of the trap jamming operation in the first virtual scene when the trap jamming operation is triggered. A process of the second virtual object being controlled to perform an interaction task in the second virtual scene is displayed. The terminal A may be a terminal used by a player controlling the first virtual object. The terminal B may be a terminal used by a player controlling the second virtual object. The player controlling the first virtual object may also observe, through the terminal A, the process of the second virtual object performing the interaction task in the second virtual scene.

In some embodiments, both a virtual object A and a virtual object B interact in the first virtual scene. In response to an operation of the virtual object A using a particular item or an item to attack the virtual object B, the virtual object B falls into another virtual scene (the second virtual scene). In the second virtual scene, the virtual object B can still normally attack another virtual object, but an attack behavior generated by the virtual object B in the second virtual scene is not converted into a score in a game. In the second virtual scene, what the virtual object B needs to do is to complete a particular task or defeat the virtual object A that causes the virtual object B to fall into the second virtual scene (for example, the virtual object A also enters the second virtual scene). In this case, the virtual object B can break the virtual scene (the second virtual scene), and return to a real scene (the first virtual scene). When the virtual object B fails to perform the task or is defeated by another virtual object, the virtual object B needs to restart to complete the task in the second virtual scene again, and the item is the same as the item in the previous task until the second virtual scene is broken. The virtual object B falling into the second virtual scene is in an unbeatable state in the first virtual scene until the second virtual scene is broken. That is, the virtual object B cannot be attacked and cannot perform any action in the first virtual scene.

In some embodiments, referring to FIG. 5A, a progress bar in a skill icon 502A is displayed on a human-computer interaction interface 501A. An item that may provide a trap jamming function (a trap jamming item) is an important item, and a use frequency of the important item needs to be controlled. Therefore, each virtual object may be equipped with one important item. The important item may be used repeatedly, but a time gap is required after each time the important item is used. 12% displayed in the progress bar shown in FIG. 5A represents that it still needs to keep waiting for a period of time, and the important item is in an unusable state at this time. Referring to FIG. 5B, a progress bar of a skill icon 502B is displayed on a human-computer interaction interface 501B. When the progress bar shown in FIG. 5B reaches 100%, the skill icon 502B is highlighted, which indicates that the important item is usable. In response to a trigger operation for the skill icon 502B in FIG. 5B, a human-computer interaction interface 501C shown in FIG. 5C is displayed, and a trap jamming item 502C is switched out, and is equipped on a shooting item.

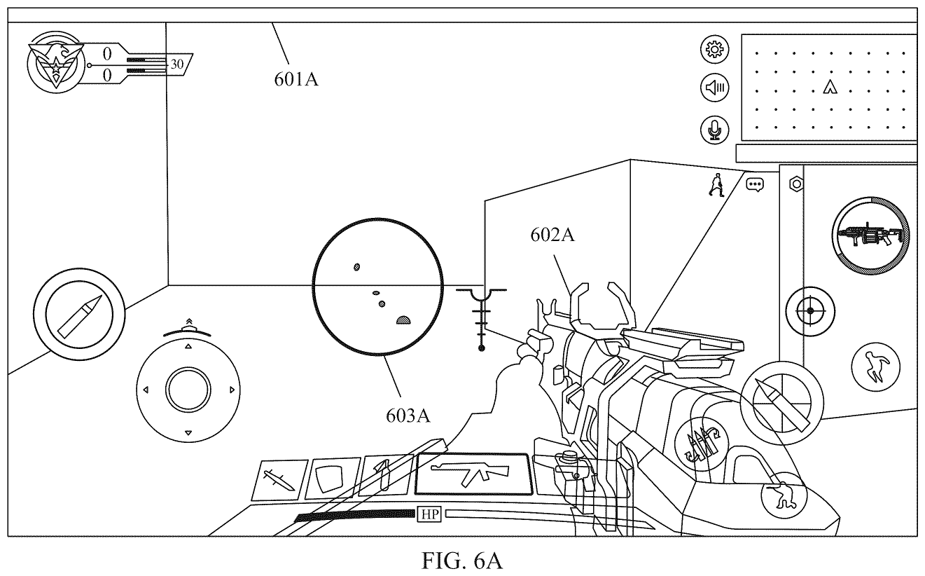

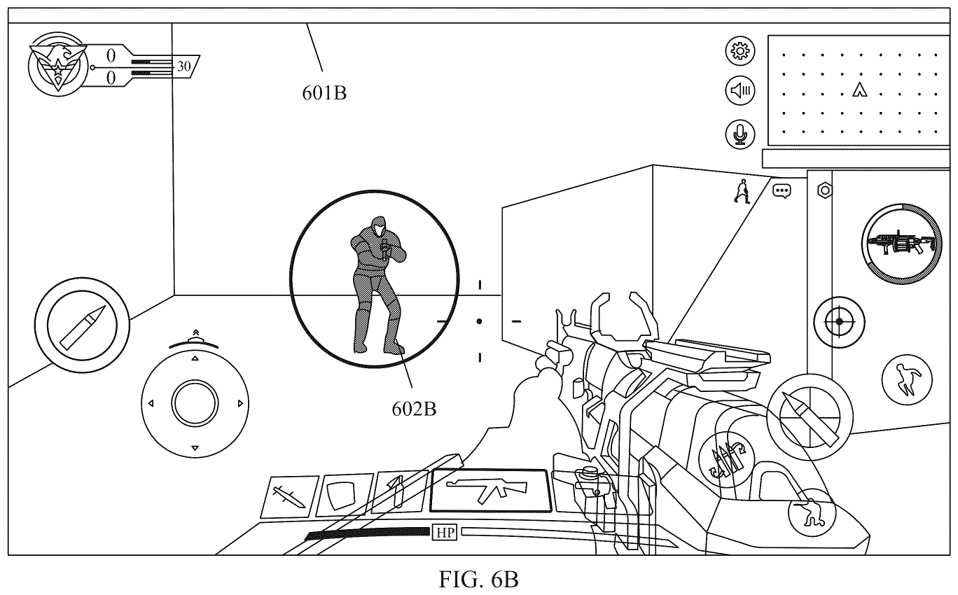

In some embodiments, referring to FIG. 6A, a trap jamming item 602A in a human-computer interaction interface 601A fires a trap missile, and a trap 603A is formed after the missile lands. Referring to FIG. 6B, a virtual object 602B is displayed on a human-computer interaction interface 601B in a trap impact range. After entering the trap impact range, the virtual object 602B falls into an unconscious state and cannot move. In this case, the virtual object 602B enters another virtual world.

In some embodiments, referring to FIG. 7A, another virtual scene (different from the virtual scene shown in the human-computer interaction interface 601A) is displayed on a human-computer interaction interface 701A. After a virtual object 702A enters the virtual scene, an indication 703A pops up in the middle of the human-computer interaction interface, and the indication 703A informs the virtual object 702A of a task that needs to be completed. Referring to FIG. 7B, a hotspot identifier 702B is displayed on a human-computer interaction interface 701B. A virtual object 702B needs to find a hotspot in a task, and occupies the hotspot. A virtual object 703B may find the hotspot identifier 702B, and enter the hotspot identifier 702B, to occupy the hotspot. Referring to FIG. 7C, a hotspot identifier 702C in a human-computer interaction interface 701C is initially white. After the virtual object occupies the hotspot, the hotspot identifier 702C turns blue. If another virtual object in the virtual scene occupies the hotspot, the hotspot identifier 702C turns red. Referring to FIG. 7D, a score control 702D is displayed on a human-computer interaction interface 701D, and the score control 702D is configured to: display a score of the virtual object controlled by a player controlling the human-computer interaction interface and a score of another virtual object, obtain a corresponding score based on a duration for which the hotspot is occupied, and complete the task when the score reaches a set value.

In some embodiments, when the life status value of the virtual object in the virtual world is zero, the task is restarted, and a player cannot leave the virtual world to return to the real world until the player completes the task. When the virtual object is in the virtual world, the virtual object in the real world is in an unbeatable state and an unmovable state. That is, if a player that cannot get out of the virtual world, the player cannot assist a teammate in a real game scene.

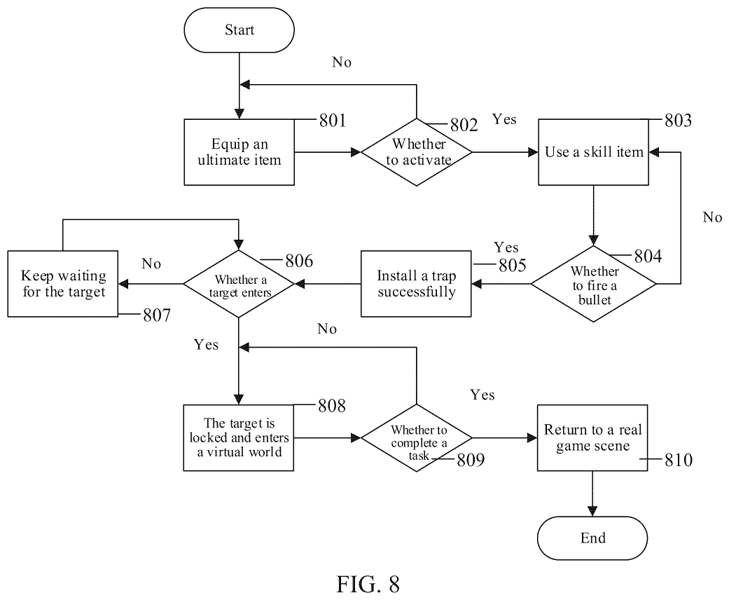

In some embodiments, referring to FIG. 8, in operation 801, a trap jamming item is equipped. In operation 802, whether to activate the trap jamming item is determined. When a determining result is yes, operation 803 is performed. In operation 803, the trap jamming item is used. In operation 804, whether to fire a bullet is determined. When a determining result is yes, operation 805 is performed. In operation 805, a trap is disposed. In operation 806, whether a target enters the trap is determined. When a determining result is no, operation 807 is performed. In operation 807, the player keeps waiting for the target. When a determining result is yes, operation 808 is performed. In operation 808, the target is locked and enters the virtual world. In operation 809, whether the task is completed is determined. When a determining result is yes, operation 810 is performed. In operation 810, the player returns to a real game scene.

In some embodiments, a random number generated by a random interface provided by a game engine is not a real random number, and the random number generated by the random interface is a pseudo random number. It is difficult to generate the real random number. A random number in a computer program is usually a pseudo random number. The pseudo random number is obtained based on a seed. Each time a random number is needed, a mathematical operation is performed on a current seed, to obtain a number, and a needed random number and a new seed are obtained based on the number. The mathematical operation is fixed. Therefore, after the seed is determined, a generated random number sequence is determined. The determined number sequence is not the real random number. However, different seeds indicate different sequences. Distribution of numbers in each sequence is random and uniform. Therefore, the number is referred to as the pseudo random number. Therefore, as long as current time is selected as the seed, sufficient randomness can be basically ensured. In this embodiment of this application, the task is randomly dispatched to the target that falls into the virtual world, and a random principle therein is the random number generation process above.

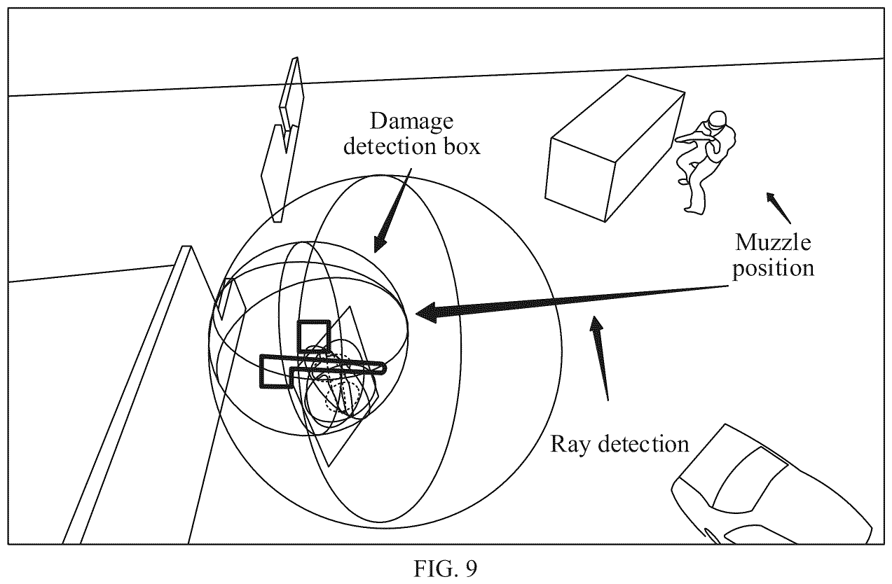

In some embodiments, during firing, a ray for detection is fired from a shooting item of a player, and then whether a damage detection box on the target is hit is detected. Referring to FIG. 9, however, because shooting to different parts causes different damage, a client calculates damage based on configuration data, and then reports the damage to a server. Finally, the server determines whether a player is dead.

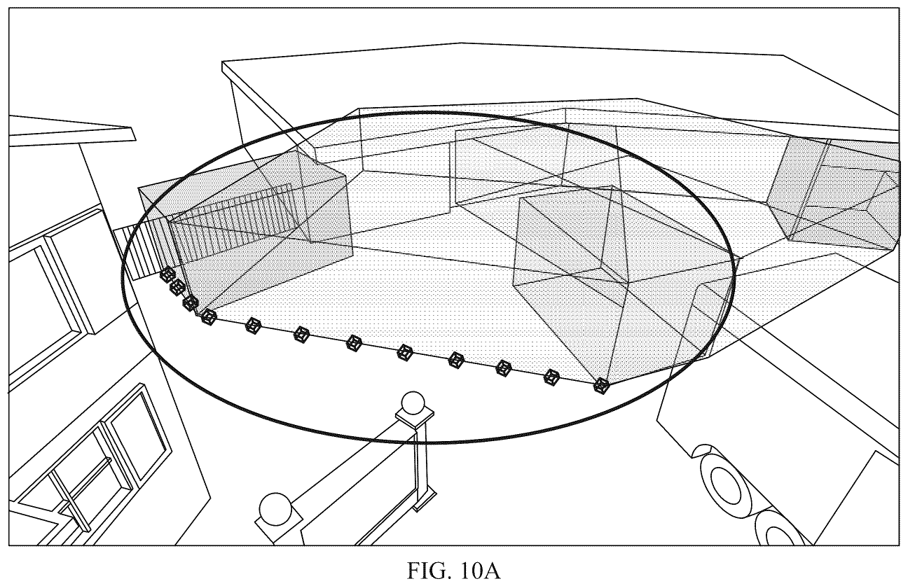

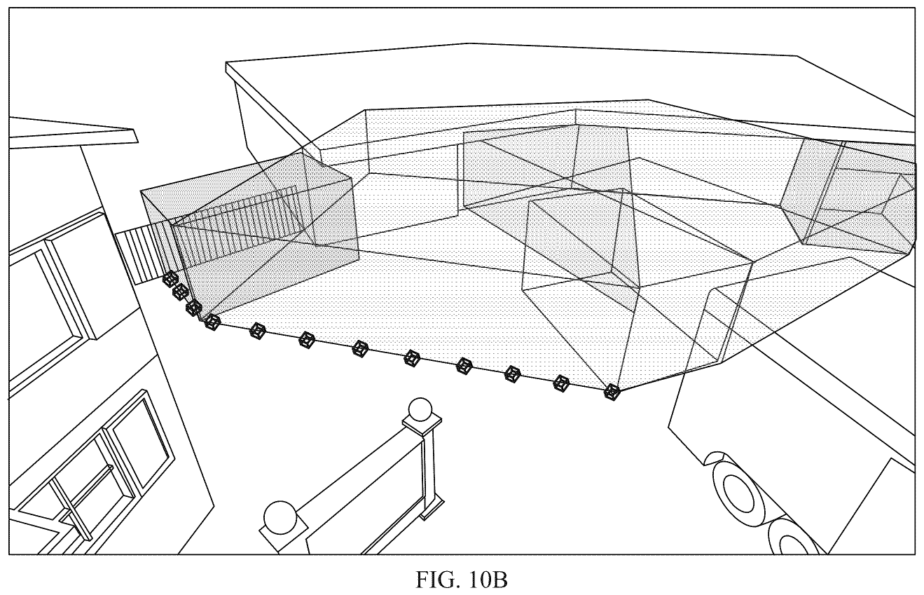

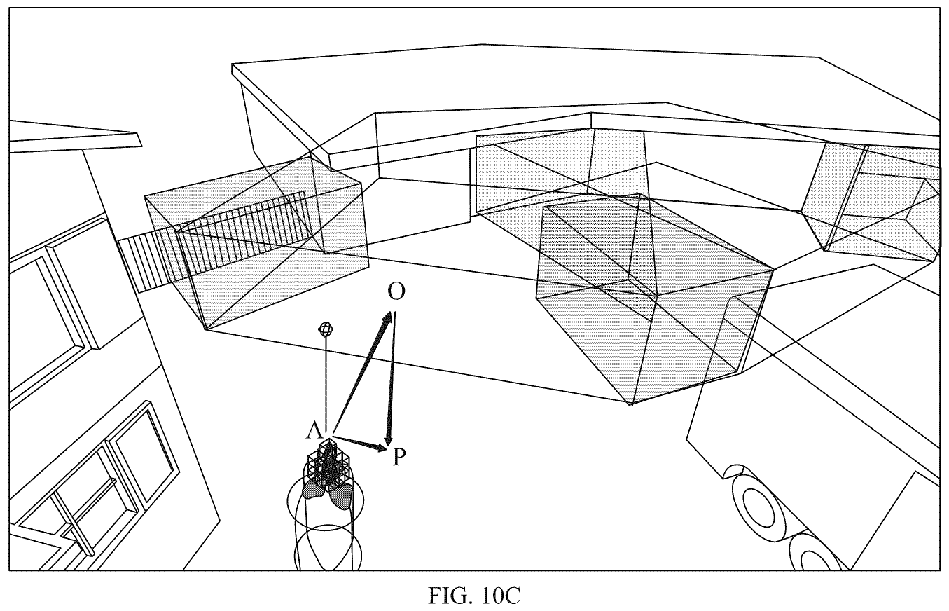

In some embodiments, in this embodiment of this application, occupying a hotspot is used as a task. After a game starts, the backend randomly generates a hotspot, and displays the hotspot in a minimap. These hotspots are not real random but are preset. For example, X hotspots are set in the minimap, and the backend randomly generates hotspots from these spots. Because hotspots cannot be placed anywhere, but as long as enough spots are set, these hotspots become random spots in the true sense. These hotspots are all a special effect, and a collision box is hung on the special effect. Referring to FIG. 10A and FIG. 10B, FIG. 10A is a generated hotspot model, and FIG. 10B is a corresponding collision box. These collision boxes are configured to detect whether a player enters or exits. When the hotspot occurs, in addition to displaying an approximate position of the hotspot on the minimap, a direction and a distance of the hotspot are further displayed on a screen. A calculation manner is shown in FIG. 10C. A player connects a line AO to a center 0 of the hotspot. OP is perpendicular to a front direction AP of a player. A distance between OP is a distance between the hotspot and a player. AP represents a direction and a distance of a center of the screen, that is, a guide spot appears to the right of the center of the screen, and a lateral distance is AP. After a player occupies the spot, a score of a player camp starts to be increased until the hotspot disappears, or an enemy camp also occupies the hotspot. When a score obtained by any party in a game reaches a target score or after game time ends, a battle is ended, and a party having a higher score achieves the final victory of the game.

In the embodiments of this application, when the embodiments of this application are applied to a specific product or technology, data related to user information, such as collection, use, and processing of the related data need to comply with the laws, regulations, and standards of related countries and regions.

The following continues to describe an exemplary structure that is of an interaction apparatus 455 in a virtual scene and that is implemented as a software module according to an embodiment of this application. In some embodiments, as shown in FIG. 2, the software module in the interaction apparatus 455 in a virtual scene stored in the memory 450 may include: a first display module 4551, configured to display a first virtual scene, the first virtual scene including a first virtual object, and the first virtual object being a virtual object controlled by a player; a first trap module 4552, configured to display a second virtual scene, and display a second virtual object in the second virtual scene in response to a trap jamming operation of the first virtual object, the second virtual object being a virtual object within an impact range of the trap jamming operation in the first virtual scene when the trap jamming operation is triggered; and a first virtual module 4553, configured to display a process of the second virtual object being controlled to perform an interaction task in the second virtual scene.

In some embodiments, the first virtual object holds a trap jamming item, and the trap jamming operation is a trigger operation of the first virtual object pointing in a target direction using the trap jamming item. The first trap module 4552 is further configured to: control a trap item fired by the trap jamming item to move along the target direction, and form a trap having the impact range at a collision position of the trap item.

In some embodiments, the first virtual object has a trap jamming skill, and the trap jamming operation is a trigger operation based on the trap jamming skill and implemented by controlling the first virtual object. The first trap module 4552 is further configured to form a trap having the impact range at a position to which the trap jamming operation points.

In some embodiments, the first trap module 4552 is further configured to: display, when the second virtual object is outside the impact range of the trap at a moment at which the trap jamming operation is triggered, a process of the second virtual object moving in the first virtual scene; and display the second virtual scene when the second virtual object moves from outside the impact range of the trap to inside the impact range of the trap in the first virtual scene.

In some embodiments, the first trap module 4552 is further configured to display the second virtual scene when the second virtual object is already within the impact range of the trap at a moment at which the trap jamming operation is triggered.

In some embodiments, the first trap module 4552 is further configured to perform any one of the following processing: continuing to display the second virtual object in the first virtual scene in response to the trap jamming operation of the first virtual object, the second virtual object being in an interaction-blocking state; or blocking displaying of the second virtual object in the first virtual scene in response to the trap jamming operation of the first virtual object.

In some embodiments, the first trap module 4552 is further configured to: before in response to a trap jamming operation of the first virtual object, display a trap jamming function being in an activated state when at least one of the following conditions is satisfied: an activation operation for the trap jamming function is received; and an interval time from a previous response to the trap jamming operation exceeds an interval time threshold, where the trap jamming function being in an activated state represents that the trap jamming operation can be responded to.

In some embodiments, the first virtual module 4553 is further configured to: display a process of the second virtual object occupying a task area in the second virtual scene; start timing from the second virtual object occupying the task area in the second virtual scene; perform timing stopping processing when the second virtual object no longer occupies the task area; display an occupation score that is positively correlated with a cumulative time of the second virtual object occupying the task area; and determine, when the occupation score reaches a set score, that the second virtual object completes the interaction task.

In some embodiments, the set score is negatively correlated with a first parameter and is positively correlated with a second parameter, the first parameter includes a distance between the second virtual object and a center of the impact range, and the second parameter is a life status value of the first virtual object when the trap jamming operation is triggered.

In some embodiments, the first virtual module 4553 is further configured to: reduce a life status value of the second virtual object in the second virtual scene when the second virtual object is attacked by a third virtual object in the second virtual scene; and initialize the life status value of the second virtual object in the second virtual scene, and set the cumulative time to zero to continue to perform the interaction task, when the life status value of the second virtual object in the second virtual scene is less than a first life status threshold.

In some embodiments, the first virtual module 4553 is further configured to: display prompt information, the prompt information being configured for indicating the second virtual object to occupy the task area; display a task area identifier in the task area, to prompt the second virtual object to enter the task area; and display the task area identifier in an occupied state in response to the second virtual object entering the task area.

In some embodiments, the first virtual module 4553 is further configured to: reduce a life status value of the first virtual object in the second virtual scene in response to an attack operation of the second virtual object on the first virtual object in the second virtual scene when the first virtual object enters the second virtual scene; and determine, when the life status value of the first virtual object in the second virtual scene is less than a second life status threshold, that the second virtual object completes the interaction task.

In some embodiments, an amount of reduction on the life status value of the first virtual object in the second virtual scene by each attack operation is positively correlated with a first parameter and is negatively correlated with a second parameter, the first parameter includes a distance between the second virtual object and a center of the impact range, and the second parameter is a life status value of the first virtual object when the trap jamming operation is triggered.

In some embodiments, the first virtual module 4553 is further configured to: control the second virtual object to exit the second virtual scene, and control the second virtual object to interact in the first virtual scene, when the second virtual object completes the interaction task in the second virtual scene.

In some embodiments, the first virtual module 4553 is further configured to: control the second virtual object to exit the second virtual scene, and control the second virtual object to interact in the first virtual scene, in response to that a life status value of the first virtual object in the first virtual scene is less than a third life status threshold when the second virtual object is in the second virtual scene.

In some embodiments, the software module in the interaction apparatus in a virtual scene stored in the memory may include: a second display module, configured to display a first virtual scene, the first virtual scene including a first virtual object; a second trap module, configured to: display a second virtual scene, and display the second virtual object in the second virtual scene in response to a trap jamming operation of the first virtual object, the second virtual object being a virtual object within an impact range of the trap jamming operation in the first virtual scene when the trap jamming operation is triggered, and the second virtual scene being another virtual scene completely different from the first virtual scene; and a second virtual module, configured to display a process of the second virtual object being controlled to perform an interaction task in the second virtual scene.

The embodiments of this application provide a computer program product. The computer program product includes computer-executable instructions or a computer program. The computer-executable instructions are stored in a computer-readable storage medium. A processor of an electronic device reads the computer-executable instructions from the computer-readable storage medium, and the processor executes the computer-executable instructions, so that the electronic device performs the interaction method in a virtual scene in the embodiments of this application.

The embodiments of this application provide a computer-readable storage medium storing computer-executable instructions. The computer-executable instructions, when executed by a processor, performing the interaction method in a virtual scene provided in the embodiments of this application.

In some embodiments, the computer-readable storage medium may be a memory such as an FRAM, a ROM, a PROM, an EPROM, an EEPROM, a flash memory, a magnetic surface memory, an optical disc, or a CD-ROM, or may be various devices including one or any combination of the memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

For example, the computer-executable instructions may, but do not necessarily correspond to a file in a file system, and may be stored as a part of a file that saves another program or data, for example, stored in one or more scripts in a hypertext markup language (HTML) file, stored in a single file dedicated to a program in discussion, or stored in a plurality of collaborative files (for example, files that store one or more modules, subprograms, or code parts).

For example, the executable instructions may be deployed to be executed on one computer device, or executed on a plurality of computer devices located at one position, or executed on a plurality of computer devices that are distributed in a plurality of positions and interconnected by a communication network.

In conclusion, according to the embodiments of this application, the second virtual object is in a static state in the first virtual scene through the trap jamming operation of the first virtual object, and the second virtual object is controlled to enter the second virtual scene. This is equivalent to that the player controlling the first virtual object can perform an operation to make the second virtual object unable to interact in the first virtual scene, to provide more interaction manners and human-computer interaction modes for game players and improve human-computer interaction diversity. The second virtual object is controlled to enter the second virtual scene, and the process of the second virtual object performing the interaction task in the second virtual scene is displayed, so that although the second virtual object is restricted in the first virtual scene, game interaction can be performed in the second virtual scene. Therefore, a game progress in the first virtual scene is not affected when an interaction requirement of the second virtual object is satisfied, and efficiency of human-computer interaction and utilization of related computing communication resources can be improved. In addition, through expansion of the virtual scene, utilization of display resources can be improved, and a broader visual space can be provided for the player.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions described above are merely examples of the embodiments of this application, and this is not intended to limit the protection scope of this application. Any modification, equivalent replacement, and improvement made within the spirit and scope of this application shall fall within the protection scope of this application.

What is claimed is:

1. A virtual object interaction method in a virtual scene performed by an electronic device, the method comprising:
displaying a first virtual scene, the first virtual scene comprising a first virtual object controlled by a first player and a second virtual object controlled by a second player, wherein the first virtual object holds a trap jamming item;
in response to a trigger operation by the first virtual object pointing in a target direction using the trap jamming item, controlling a trap item fired by the trap jamming item to move along the target direction and forming a trap having an impact range at a collision position of the trap item;
in accordance with a determination that the second virtual object is within the impact range of the trap in the first virtual scene, replacing the first virtual scene with a second virtual scene, wherein the second virtual scene includes the second virtual object and not the first virtual object; and
displaying a process of the second virtual object being controlled by the second player to perform an interaction task in the second virtual scene.

2. The method according to claim 1, wherein, before replacing the first virtual scene with the second virtual scene, the method comprises:
displaying a process of the second virtual object moving outside the impact range of the trap in the first virtual scene until the second virtual object moves inside the impact range of the trap.

3. The method according to claim 1, further comprising:
changing the second virtual object in the first virtual scene from an active state to an interaction-blocking state when the second virtual object moves inside the impact range of the trap, wherein the second virtual object is prevented from interacting with any other virtual object in the first virtual scene.

4. The method according to claim 1, wherein before the trigger operation by the first virtual object, the method further comprises:
displaying a trap jamming function being in an activated state when at least one of the following conditions is satisfied:
an activation operation for the trap jamming function is received; and
an interval time from a previous response to the trap jamming operation exceeds an interval time threshold, wherein
the trap jamming function being in the activated state represents that the first virtual object can perform the trigger operation.

5. The method according to claim 1, wherein the displaying the process of the second virtual object controlled by the second player performing the interaction task in the second virtual scene comprises:
displaying a process of the second virtual object occupying a task area in the second virtual scene, and starting timing from the second virtual object occupying the task area in the second virtual scene;
stopping the timing when the second virtual object no longer occupies the task area;
displaying an occupation score that is positively correlated with a cumulative time of the second virtual object occupying the task area; and
determining, when the occupation score reaches a set score, that the second virtual object completes the interaction task.

6. The method according to claim 5, wherein the set score is negatively correlated with a distance between the second virtual object and a center of the impact range and is positively correlated with a life status value of the first virtual object when performing the trigger operation.

7. The method according to claim 5, further comprising:
reducing a life status value of the second virtual object in the second virtual scene when the second virtual object is attacked by a third virtual object in the second virtual scene; and
initializing the life status value of the second virtual object in the second virtual scene, and setting the cumulative time to zero to continue to perform the interaction task, when the life status value of the second virtual object in the second virtual scene is less than a first life status threshold.

8. The method according to claim 5, wherein the displaying a process of the second virtual object occupying a task area in the second virtual scene comprises:
displaying prompt information, the prompt information indicating the second virtual object to occupy the task area;
displaying a task area identifier in the task area, to prompt the second virtual object to enter the task area; and
displaying the task area identifier in an occupied state in response to the second virtual object entering the task area.

9. The method according to claim 1, wherein the displaying the process of the second virtual object being controlled by the second player to perform the interaction task in the second virtual scene comprises:
reducing a life status value of the first virtual object in the second virtual scene in response to an attack operation of the second virtual object on the first virtual object in the second virtual scene when the first virtual object enters the second virtual scene; and
determining, when the life status value of the first virtual object in the second virtual scene is less than a second life status threshold, that the second virtual object completes the interaction task.

10. The method according to claim 9, wherein an amount of reduction on the life status value of the first virtual object in the second virtual scene by each attack operation is positively correlated with a distance between the second virtual object and a center of the impact range and is negatively correlated with a life status value of the first virtual object when performing the trigger operation.

11. The method according to claim 1, further comprising:
controlling the second virtual object to exit the second virtual scene and return to the first virtual scene, when the second virtual object completes the interaction task in the second virtual scene.

12. An electronic device, comprising:
a memory, configured to store computer-executable instructions; and
a processor, configured to implement a virtual object interaction method in a virtual scene when executing the computer-executable instructions stored in the memory, the method including:
displaying a first virtual scene, the first virtual scene comprising a first virtual object controlled by a first player and a second virtual object controlled by a second player, wherein the first virtual object holds a trap jamming item;
in response to a trigger operation by the first virtual object pointing in a target direction using the trap jamming item, controlling a trap item fired by the trap jamming item to move along the target direction and forming a trap having an impact range at a collision position of the trap item;
in accordance with a determination that the second virtual object is within the impact range of the trap in the first virtual scene, replacing the first virtual scene with a second virtual scene, wherein the second virtual scene includes the second virtual object and not the first virtual object; and
displaying a process of the second virtual object being controlled by the second player to perform an interaction task in the second virtual scene.

13. The electronic device according to claim 12, wherein, before replacing the first virtual scene with the second virtual scene, the method comprises:
displaying a process of the second virtual object moving outside the impact range of the trap in the first virtual scene until the second virtual object moves inside the impact range of the trap.

14. The electronic device according to claim 12, wherein the method further comprises:
changing the second virtual object in the first virtual scene from an active state to an interaction-blocking state when the second virtual object moves inside the impact range of the trap, wherein the second virtual object is prevented from interacting with any other virtual object in the first virtual scene.

15. The electronic device according to claim 12, wherein, before the trigger operation by the first virtual object, the method further comprises:
displaying a trap jamming function being in an activated state when at least one of the following conditions is satisfied:
an activation operation for the trap jamming function is received; and
an interval time from a previous response to the trap jamming operation exceeds an interval time threshold, wherein
the trap jamming function being in the activated state represents that the first virtual object can perform the trigger operation.

16. The electronic device according to claim 12, wherein the displaying the process of the second virtual object controlled by the second player performing the interaction task in the second virtual scene comprises:
displaying a process of the second virtual object occupying a task area in the second virtual scene, and starting timing from the second virtual object occupying the task area in the second virtual scene;
stopping the timing when the second virtual object no longer occupies the task area;
displaying an occupation score that is positively correlated with a cumulative time of the second virtual object occupying the task area; and
determining, when the occupation score reaches a set score, that the second virtual object completes the interaction task.

17. The electronic device according to claim 16, wherein the set score is negatively correlated with a distance between the second virtual object and a center of the impact range and is positively correlated with a life status value of the first virtual object when performing the trigger operation.

18. The electronic device according to claim 12, wherein the displaying the process of the second virtual object being controlled by the second player to perform the interaction task in the second virtual scene comprises:
reducing a life status value of the first virtual object in the second virtual scene in response to an attack operation of the second virtual object on the first virtual object in the second virtual scene when the first virtual object enters the second virtual scene; and
determining, when the life status value of the first virtual object in the second virtual scene is less than a second life status threshold, that the second virtual object completes the interaction task.

19. The electronic device according to claim 12, wherein the method further comprises:
controlling the second virtual object to exit the second virtual scene and return to the first virtual scene, when the second virtual object completes the interaction task in the second virtual scene.

20. A non-transitory computer-readable storage medium, having computer-executable instructions stored therein, the computer-executable instructions, when executed by a processor of an electronic device, causing the electronic device to implement a virtual object interaction method in a virtual scene including:
displaying a first virtual scene, the first virtual scene comprising a first virtual object controlled by a first player and a second virtual object controlled by a second player, wherein the first virtual object holds a trap jamming item;
in response to a trigger operation by the first virtual object pointing in a target direction using the trap jamming item, controlling a trap item fired by the trap jamming item to move along the target direction and forming a trap having an impact range at a collision position of the trap item;
in accordance with a determination that the second virtual object is within the impact range of the trap in the first virtual scene, replacing the first virtual scene with a second virtual scene, wherein the second virtual scene includes the second virtual object and not the first virtual object; and
displaying a process of the second virtual object being controlled by the second player to perform an interaction task in the second virtual scene.
